(19) United States
(12) Patent Application Publication
(10) Pub. No.: US 2014/0258696 A1
(43) Pub. Date: Sep. 11, 2014

(54) STRIDED TARGET ADDRESS PREDICTOR (STAP) FOR INDIRECT BRANCHES

(71) Applicant: QUALCOMM INCORPORATED, San Diego, CA (US)

(72) Inventor: Shekhar S. Srikantaiah, Cary, NC (US)

(73) Assignee: QUALCOMM INCORPORATED, San Diego, CA (US)

(21) Appl. No.: 13/784,964

(22) Filed: Mar. 5, 2013

(51) Int. Cl. G06F 9/30

(52) U.S. Cl. CPC G06F 9/30058
USPC 712/239

(57) ABSTRACT

Systems and methods for predicting an indirect branch target address. A strided target address predictor (STAP) system can observe a striding pattern from a previous indirect branch target. The system can predict a target address based on the observed striding pattern. The system can initialize a confidence counter. The system can determine a previous indirect branch target address. The system can determine a predicted target address. The system can determine an actual target address, determine if the predicted target has the same address as the actual target, determine if a confidence counter is less than a prediction threshold if the predicted target has the same address as the actual target, and if the confidence counter is less than a prediction threshold, increase the value of the confidence counter, reinitialize the confidence counter, assign the value of the difference between the actual target and the previous indirect branch target to the stride length, and assign the address of the actual target to the previous indirect branch target value.

### FIELD OF DISCLOSURE

Disclosed embodiments relate to predicting indirect branch target addresses. More particularly, exemplary embodiments are directed to detecting strides in indirect branch target addresses.

### BACKGROUND

Virtual function calls may be used in most object oriented languages. These languages promote a polymorphic programming style with dynamic binding. In most implementations of runtime environments for these languages, indirect branches are used to implement virtual function calls. A register is loaded with a dynamically determined function pointer. The register value is used as a branch target address or an indirect branch.

There are a large number of small virtual functions in JavaScript apps and industry standard benchmarks. There is sequentially placed code in memory for successive virtual function calls. A consequence of all this can be extremely high branch target mispredictions using state-of-the-art prediction techniques.

Some previously proposed indirect branch target address predictors implement a Branch Target Buffer (BTB) for prediction purposes. These predictors use a previous target of the same branch program counter (PC) as the predicted target. However, these methods fail to predict correctly if the same PC of an indirect branch branches to different targets each time (due to the presence of dynamic binding). A more complex organization of a branch target address cache (BTAC) does not change the fundamental target prediction depending on previous target of the same branch.

### SUMMARY

Exemplary embodiments of the invention are directed to systems and method for detecting strides in indirect branch target addresses.

For example, an exemplary embodiment is directed to a method for predicting strided target addresses predictor (STAP) for indirect branches comprising: observing a striding pattern from at least one previous indirect branch target; and predicting a target address based on the observed striding pattern.

Another exemplary embodiment is directed to an apparatus comprising: a striding pattern observation circuit configured to observe a striding pattern from at least one previous indirect branch target; and a target address predictor circuit configured to predict a target address based on the observed striding pattern.

Yet another exemplary embodiment is directed to a strided target address predictor (STAP) system comprising: means for observing a striding pattern from at least one previous indirect branch target; and means for predicting a target address based on the observed striding pattern.

Another exemplary embodiment is directed to a non-transitory computer-readable storage medium comprising code, which, when executed by a processor, causes the processor to perform operations for predicting indirect branch target addresses, the non-transitory computer-readable storage medium comprising: code for observing a striding pattern from at least one previous indirect branch target; and code for predicting a target address based on the observed striding pattern.

Still another exemplary embodiment is directed to a method comprising: initializing a confidence counter; determining a previous indirect branch target address; determining a predicted target address; determining an actual target address; determining if the predicted target has the same address as the actual target; if the predicted target has the same address as the actual target, determining if the confidence counter is less than a prediction threshold and if the confidence counter is less than the prediction threshold, increasing the value of the confidence counter; if the predicted target does not have the same address as the actual target, reinitializing the confidence counter; assigning the value of the difference between the actual target and the previous indirect branch target to a stride length; and assigning the address of the actual target to the previous indirect branch target value.

Another exemplary embodiment is directed to an apparatus comprising: a processor configured to validate the prediction of indirect branch target addresses; a confidence counter initialization circuit configured to initialize a confidence counter; a previous indirect branch target address determination circuit configured to determine a previous indirect branch target address; a predicted target address determination circuit configured to determine a predicted target address; and a confidence level circuit configured to: determine an actual target address; determine if the predicted target has the same address as the actual target; if the predicted target has the same address as the actual target, determine if a confidence counter is less than a prediction threshold if the predicted target has the same address as the actual target, and if the confidence counter is less than a prediction threshold, increase the value of the confidence counter, and if the predicted target does not have the same address as the actual target, reinitialize the confidence counter; assign the value of the difference between the actual target and the previous indirect branch target to the stride length; and assign the address of the actual target to the previous indirect branch target value.

One aspect of this invention is stride based target address prediction. A predicted target is newly computed based on an observed striding pattern. It is almost always different from the previous target address of the same branch, with the exact same history. An algorithm is used to detect strides with confidence and use a strided predictor when confidence is established.

### BRIEF DESCRIPTION OF THE DRAWINGS

The accompanying drawings are presented to aid in the description of embodiments of the invention and are provided solely for illustration of the embodiments and not limitation thereof.

FIG. 1 is a simplified schematic of a processing system configured according to exemplary embodiments.

FIG. 2 illustrates an operational flow of a method for predicting indirect branch target addresses.

FIG. 3 illustrates an operational flow of a method for validating the prediction of indirect branch target addresses.

FIG. 4 shows an exemplary observed strided pattern in an internal benchmark.

FIG. 5 illustrates an exemplary wireless communication system in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

An “indirect branch” is a program control instruction. Rather than specifying the address of the next instruction to execute, the indirect branch specifies where the address is located. A “stride length” is the distance separating elements that are to be gathered into a single location, such as a register. A “single stride” is a stride based on a constant distance separating elements which can be used to create a single pattern. The term “multiple strides” denotes more than one stride, each based on a distinct constant distance separating elements, which can be combined to create a recognizable pattern.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

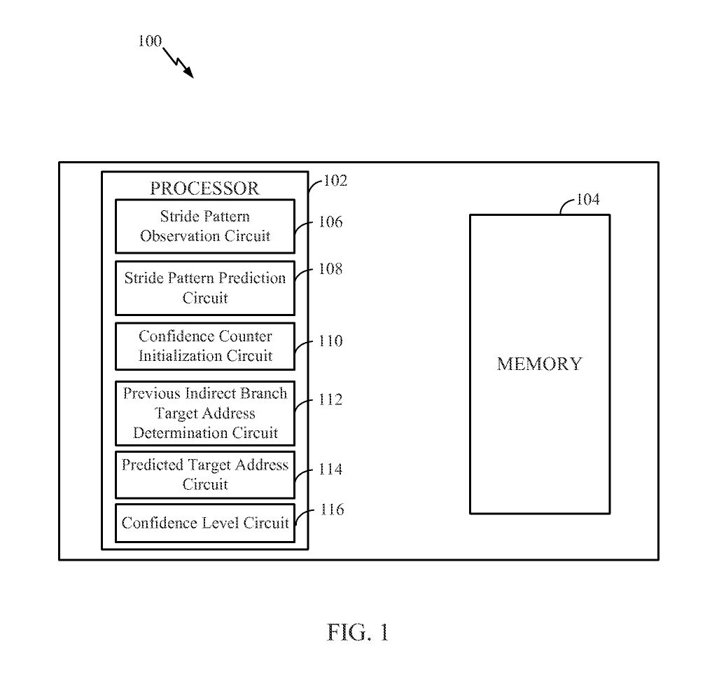

With reference now to FIG. 1, there is shown a simplified schematic of an exemplary processing system 100. Processing system 100 is shown to comprise processor 102 coupled to memory 104. While not illustrated, processing system 100 may comprise various other components, such as one or more instruction and/or data caches, I/O devices, coprocessors, etc. as are well known in the art. Memory 104 may be byte-addressable and comprise instructions which may be unaligned, or aligned at 32-bit boundaries (i.e., both instructions in compressed mode and classic mode, respectively). Processor 102 may be configured to execute instructions in the classic mode as well as the compressed mode. The processor 102 can be disposed in various electronic devices, including a mobile device (e.g., a cellular telephone, a satellite telephone, a pager, a personal digital assistant (PDA), a smartphone), a Voice over IP (VoIP) device, a navigation device, an electronic book, a media player, a desktop computer, a laptop computer, and a gaming console.

In a non-limiting exemplary embodiment, the processor 102 can include a stride pattern observation circuit 106 and a stride pattern prediction circuit 108. The stride pattern observation circuit can observe a striding pattern from at least one previous indirect target address. The stride pattern prediction circuit 108 can then predict a target address based on the observed striding pattern. In some embodiments, a predicted target address can be a sum of a previous indirect branch target plus a stride length.

The processor 102 can also include a confidence counter initialization circuit 110, a previous indirect target address determination circuit 112, a predicted target address circuit 114, and a confidence level circuit 116. The confidence counter initialization circuit 110 can initialize a confidence counter. The previous indirect target address determination circuit 112 can determine a previous indirect branch target value. The predicted target address circuit 114 can determine a predicted target address has the same address as the actual target. The confidence level circuit 116 can determine an actual target address and a confidence level. In some embodiments, the confidence level is based on the consistency of the observed striding pattern.

In some embodiments, the target address is predicted when the confidence level reaches a prediction threshold. If the predicted target address circuit 114 determines that the predicted target has the same address as the actual target, the confidence level circuit 116 can then determine if the confidence counter is less than the prediction threshold. If the confidence level circuit 116 determines that the confidence counter is less than the prediction threshold, the confidence level circuit 116 can then increase the value of the confidence counter. If the processor 102, however, determines that the predicted target does not have the same address as the actual target, the confidence level circuit 116 can decrease the value of or reinitialize the confidence counter.

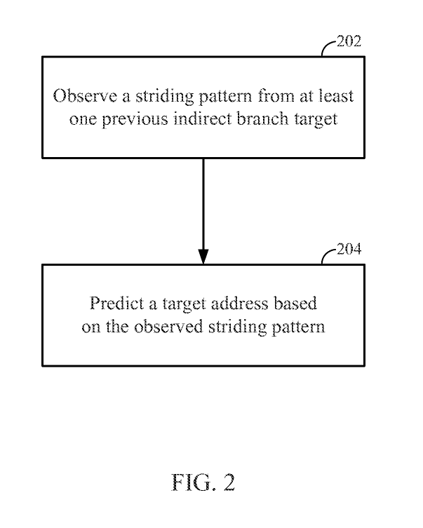

The confidence level circuit 116 can assign the value of the difference between the actual target and the previous indirect branch target to a stride length. The confidence level circuit 116 can also assign the value of the predicted target to the actual target. It will be appreciated that embodiments include various methods for performing the processes, functions and/or algorithms disclosed herein. For example, as illustrated in FIG. 2, an embodiment can include a method of predicting an indirect branch target address comprising: observing a striding pattern from at least one previous indirect branch target (e.g., a stride length that is the distance separating elements in a single location, such as a register)—Block 202; and predicting a target address based on the observed striding pattern (e.g., adding a stride length to a previous indirect branch target address to determine a predicted target address)—Block 204.

Similar to FIG. 2, other embodiments of predicting an indirect branch target address can be implemented using different approaches. TABLE 1 shows an embodiment of predicting an indirect branch target address using C.

TABLE 1
Prediction

```
if(ConfidenceCounter == Lmin)
  {
    PredictedTarget = PreviousIndirectBranchTarget + StrideLength;
  }
```

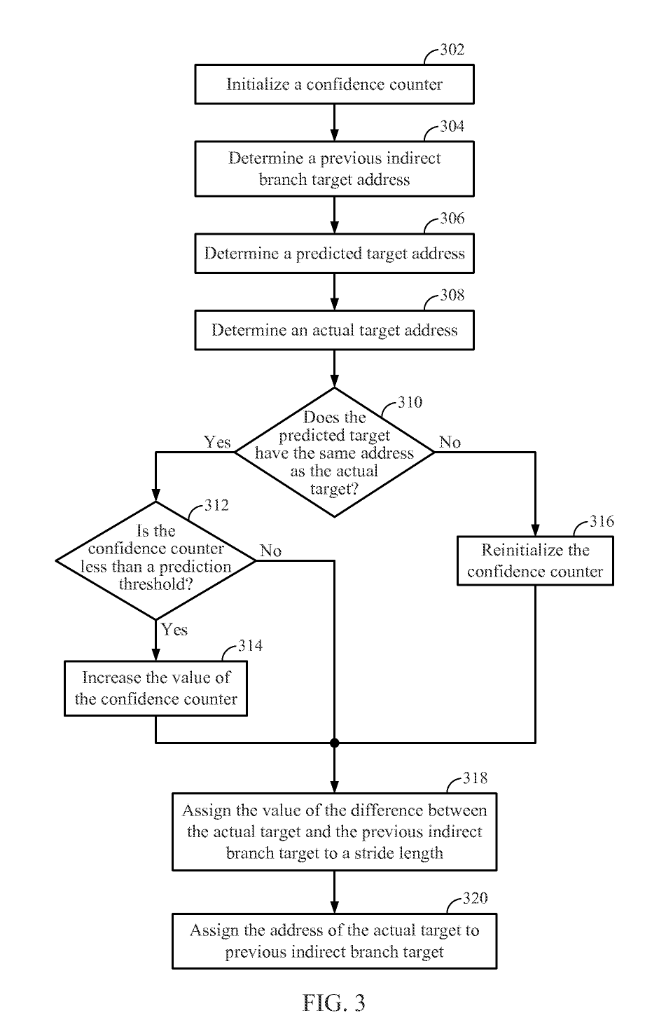

As illustrated in FIG. 3, an embodiment can include a method of validating a prediction of an indirect target branch address comprising: initializing a confidence counter (e.g., a counter that can track successful predictions)—Block 302; determining a previous indirect branch target address (e.g., receiving the address of the prior indirect target branch)—Block 304; determining a predicted target address (e.g., adding a stride length to the previous indirect branch target address)—Block 306; determining an actual target address (e.g., receiving the address of the next indirect target branch)—Block 308; and determining if the predicted target has the same address as the actual target (e.g., comparing the address of the predicted target and the address of the actual target to see if they are the same)—Block 310.

When the predicted target has the same address as the actual target, the method comprises determining if the confidence counter is less than a prediction threshold (e.g., a minimum threshold that determines whether predictions should be utilized)—Block 312. If the confidence counter is less than the prediction threshold, the embodiment can comprise increasing the value of the confidence counter (e.g., adding value to the confidence counter so that it becomes closer or equal to the value of the prediction threshold)—Block 314; otherwise, reinitializing the confidence counter (e.g., setting the counter back to the value prior to any increase to the confidence counter's value)—Block 316. Alternatively, block 316 may comprise decreasing the value of the confidence counter.

The embodiment can comprise assigning the value of the difference between the actual target and the previous indirect branch target to a stride length (e.g. using the distance separating the actual target and the previous indirect branch target in a register as the stride length)—Block 318; and assigning the address of the actual target to the previous indirect branch target address (e.g., replacing the address of the previous indirect branch target with the actual target address so that the next prediction can be evaluated)—Block 320.

Similar to FIG. 3, other embodiments of validating a prediction of an indirect target branch address can be implemented using different approaches. TABLE 2 shows an embodiment of validating a prediction of an indirect target branch address using C.

TABLE 2
On committing an indirect branch:

```
if(PredictedTarget == ActualTarget)
  {
    if(ConfidenceCounter < Lmin)
      {
          ConfidenceCounter++;
      }
  }
else
  {
    ConfidenceCounter=0;
  }
StrideLength = ActualTarget - PreviousIndirectBranchTarget;
PreviousIndirectBranchTarget = ActualTarget;
```

More than one embodiment may be implemented. For example, the embodiments in FIGS. 2-3 can be implemented simultaneously. The embodiments in FIGS. 2-3 can also be implemented in series. The embodiment described in FIG. 3 can be implemented periodically or randomly while the embodiment described in FIG. 2 can be implemented continuously.

In some embodiments, other existing schemes may be used to enhance the prediction of indirect branch targets. For example, when the confidence counter is not high, BTB predictions can be used.

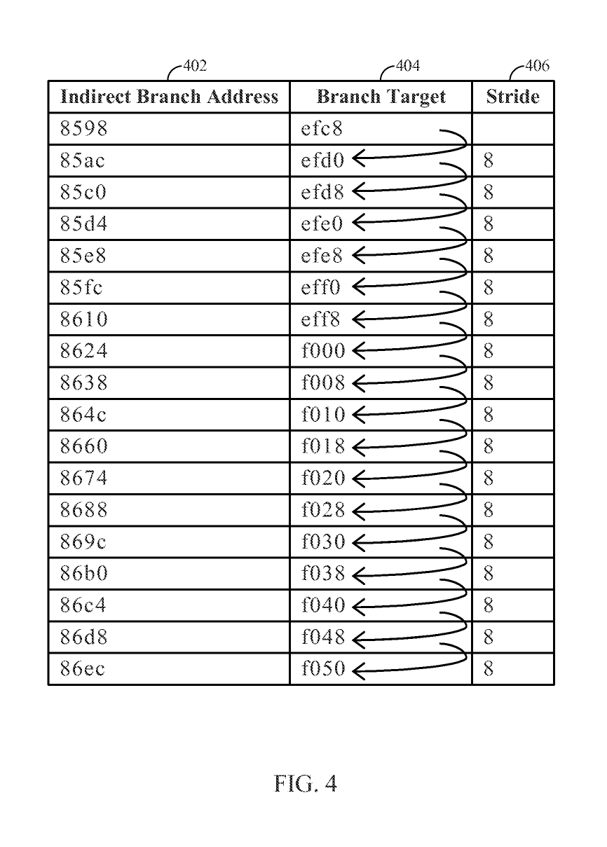

FIG. 4 shows an illustration for detecting strides in indirect branch target addresses. In FIG. 4, a list of indirect branch addresses 402 is compared to corresponding branch target addresses 404. The difference between a branch target address and the branch target address following it is shown as a pattern of strides 406 of successive indirect branches. In some embodiments, the striding pattern is based on a single stride. For example, the difference between an actual target and a previous indirect branch target can be 8 bytes every time. In some embodiments, the striding pattern is based on a stride length. For example, the striding pattern can be a pattern based on the stride length. In an instance where the striding pattern is based on a single stride, the stride length may repeat each time so that the difference between the actual target and the previous indirect branch target is the same number of bytes each time. As shown in FIG. 4, the stride length 406 is 8 bytes every time between the changing branch target addresses 404.

In some embodiments, the striding pattern can be based on multiple stride lengths of different values. For example, the difference between branch targets can be three 4-bit strides and then one 8-bit stride. Thereafter, this three 4-bit, one 8-bit pattern can repeat, and the subsequent addresses can be predicted using the multiple stride length striding pattern. In some embodiments, stride information (e.g., a striding pattern, stride length, a confidence level) can be stored in a single register. For example, in case of a single-stride pattern, the single register can hold the value of the “StrideLength” as computed above in Table 2. In another example, a set of registers can store a sequence of strides when computing multi-stride patterns.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

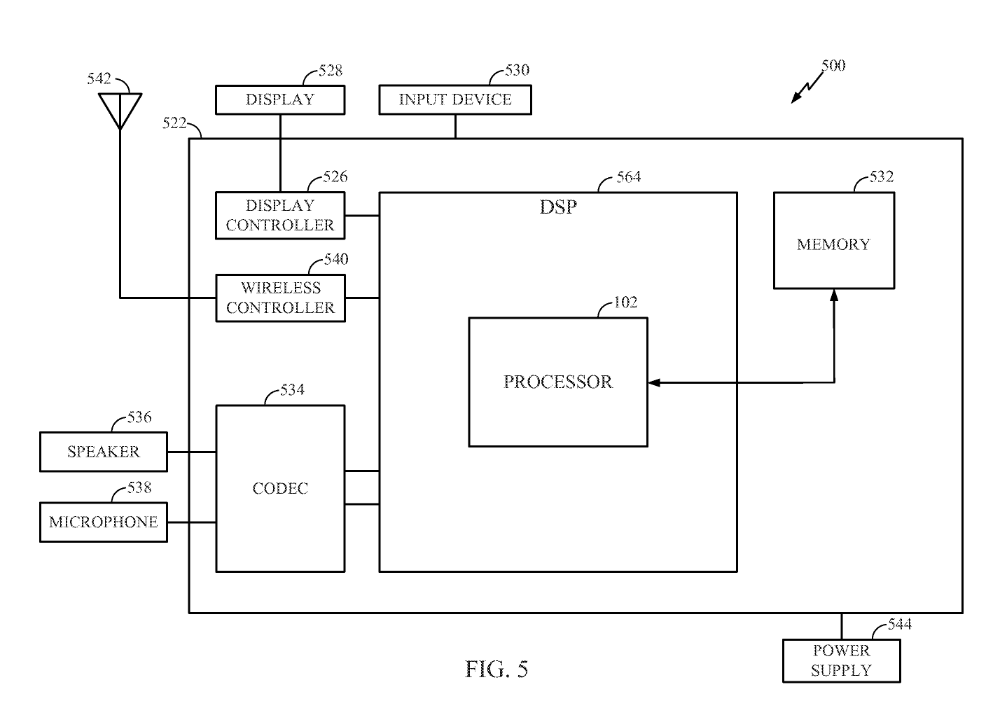

Referring to FIG. 5, a block diagram of a particular illustrative embodiment of a wireless device that includes a multi-core processor configured according to exemplary embodiments is depicted and generally designated 500. The device 500 includes a digital signal processor (DSP) 564, which may include processor 102 of FIG. 1 coupled to memory 532 as shown. FIG. 5 also shows display controller 526 that is coupled to DSP 564 and to display 528. Coder/decoder (CODEC) 534 (e.g., an audio and/or voice CODEC) can be coupled to DSP 564. Other components, such as wireless controller 540 (which may include a modem) are also illustrated. Speaker 536 and microphone 538 can be coupled to CODEC 534. FIG. 5 also indicates that wireless controller 540 can be coupled to wireless antenna 542. In a particular embodiment, DSP 564, display controller 526, memory 532, CODEC 534, and wireless controller 540 are included in a system-in-package or system-on-chip device 522.

In a particular embodiment, input device 530 and power supply 544 are coupled to the system-on-chip device 522. Moreover, in a particular embodiment, as illustrated in FIG. 5, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 depicts a wireless communications device, DSP 564 and memory 532 may also be integrated into a set-top box, a music player, a video player, an entertainment unit, a navigation device, a personal digital assistant (PDA), a fixed location data unit, or a computer. A processor (e.g., DSP 564) may also be integrated into such a device.

Accordingly, an embodiment of the invention can include a computer readable media embodying a method for predicting indirect branch target addresses. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method for predicting strided target addresses predictor (STAP) for indirect branches comprising:
observing a striding pattern from at least one previous indirect branch target; and
predicting a target address based on the observed striding pattern.

2. The method of claim 1, further comprising a predicted target address which is a sum of a previous indirect branch target plus a stride length.

3. The method of claim 1, wherein a confidence level is based on the consistency of the observed striding pattern.

4. The method of claim 3, wherein the target address is predicted when the confidence level reaches a threshold.

5. The method of claim 1, wherein the striding pattern is based on a single stride.

6. The method of claim 1, wherein the striding pattern is based on multiple strides.

7. The method of claim 1, wherein the striding pattern is based on a stride length.

8. The method of claim 7, further comprising:
determining an actual target address;
determining if the predicted target has the same address as the actual target;
if the predicted target has the same address as the actual target, determining if a confidence counter is less than a prediction threshold and if the confidence counter is less than the prediction threshold, increasing the value of the confidence counter;
if the predicted target does not have the same address as the actual target, reinitializing the confidence counter;
assigning the value of the difference between the actual target and the previous indirect branch target to the stride length; and
assigning the value of the actual target to the previous indirect branch target address.

9. An apparatus comprising:
a striding pattern observation circuit configured to observe a striding pattern from at least one previous indirect branch target; and
a target address predictor circuit configured to predict a target address based on the observed striding pattern.

10. The apparatus of claim 9, wherein the striding pattern is based on a single stride.

11. The apparatus of claim 9, wherein the striding pattern is based on multiple strides.

12. The apparatus of claim 9, wherein the striding pattern is based on a stride length.

13. The apparatus of claim 12, further comprising a confidence level circuit configured to:
determine an actual target address;
determine if the predicted target has the same address as the actual target;
if the predicted target has the same address as the actual target, determine if a confidence counter is less than a prediction threshold and if the confidence counter is less than a prediction threshold, increase the value of the confidence counter; and
if the predicted target does not have the same address as the actual target, reinitialize the confidence counter;
assign the value of the difference between the actual target and the previous indirect branch target to the stride length; and
assign the address of the actual target to the previous indirect branch target value.

14. The apparatus of claim 9, wherein the apparatus is disposed in a processor.

15. The apparatus of claim 14, wherein the processor is disposed in at least one of: a mobile device (e.g. a cellular telephone, a satellite telephone, a pager, a personal digital assistant (PDA), a smartphone), a Voice over IP (VoIP) device, a navigation device, an electronic book, a media player, a desktop computer, a laptop computer, and a gaming console.

16. A strided target address predictor (STAP) system comprising:
means for observing a striding pattern from at least one previous indirect branch target; and
means for predicting a target address based on the observed striding pattern.

17. The system of claim 16, further comprising
means for determining an actual target address;
means for determining if the predicted target has the same address as the actual target;
means for determining if a confidence counter is less than a prediction threshold and if the confidence counter is less than the prediction threshold, increasing the value of the confidence counter, if the predicted target has the same address as the actual target;
means for reinitializing the confidence counter, if the predicted target does not have the same address as the actual target;
means for assigning the value of the difference between the actual target and the previous indirect branch target to the stride length; and
means for assigning the value of the actual target to the previous indirect branch target address.

18. A non-transitory computer-readable storage medium comprising code, which, when executed by a processor, causes the processor to perform operations for predicting indirect branch target addresses, the non-transitory computer-readable storage medium comprising:
code for observing a striding pattern from at least one previous indirect branch target; and
code for predicting a target address based on the observed striding pattern.

19. The non-transitory computer-readable storage medium of claim 18, further comprising:
code for determining an actual target address;
code for determining if the predicted target has the same address as the actual target;
code for determining if a confidence counter is less than a prediction threshold and if the confidence counter is less than the prediction threshold, increasing the value of the confidence counter, if the predicted target has the same address as the actual target;
code for reinitializing the confidence counter, if the predicted target does not have the same address as the actual target;
code for assigning the value of the difference between the actual target and the previous indirect branch target to the stride length; and
code for assigning the value of the actual target to the previous indirect branch target address.

20. A method comprising:
initializing a confidence counter;
determining a previous indirect branch target address;
determining a predicted target address;
determining an actual target address;
determining if the predicted target has the same address as the actual target;
if the predicted target has the same address as the actual target, determining if the confidence counter is less than a prediction threshold and if the confidence counter is less than the prediction threshold, increasing the value of the confidence counter;
if the predicted target does not have the same address as the actual target, reinitializing the confidence counter;
assigning the value of the difference between the actual target and the previous indirect branch target to a stride length; and
assigning the address of the actual target to the previous indirect branch target value.

21. An apparatus comprising:
a processor configured to validate the prediction of indirect branch target addresses;
a confidence counter initialization circuit configured to initialize a confidence counter;
a previous indirect branch target address determination circuit configured to determine a previous indirect branch target address;
a predicted target address determination circuit configured to determine a predicted target address; and
a confidence level circuit configured to:
determine an actual target address,
determine if the predicted target has the same address as the actual target,
if the predicted target has the same address as the actual target, determine if a confidence counter is less than a prediction threshold if the predicted target has the same address as the actual target, and if the confidence counter is less than a prediction threshold, increase the value of the confidence counter, and
if the predicted target does not have the same address as the actual target, reinitialize the confidence counter,
assign the value of the difference between the actual target and the previous indirect branch target to the stride length, and
assign the address of the actual target to the previous indirect branch target value.
